(19) United States
(12) Patent Application Publication
(10) Pub. No.: US 2006/0282863 A1
(43) Pub. Date: Dec. 14, 2006

(54) Interactive television framework interfacing with a home networking domain

(75) Inventors: Dennis Bushmitch, Somerset, NJ (US); Alan Kaplan, Princeton, NJ (US); Rajesh Bhagwandas Khandelwal, Bridgewater, NJ (US)

Correspondence Address: GREGORY A. STOBBS, 5445 CORPORATE DRIVE, SUITE 400, TROY, MI, 48098, US

(73) Assignee: Matsushita Electric Industrial Co. Ltd., Osaka (JP)

(21) Appl. No.: 11/151,775

(22) Filed: Jun. 14, 2005

(51) Int. Cl. H04N 7/18

(52) U.S. Cl. 725/80; 725/81; 725/78

(57) ABSTRACT

An interactive television framework is provided for interfacing with a home networking domain. The interactive television framework includes: a carousel access mechanism that is operable to access object carousel data from a remotely located data carousel; and a carousel proxying agent in data communication with the carousel access mechanism. The carousel proxying agent actively translates object carousel data into home device messages which are defined according to a plug-and-play protocol for transmission in the home networking domain.

### FIELD OF THE INVENTION

The present invention relates generally to home networking and, more particularly, to an interactive television framework for interfacing interactive broadcasting application and services with a home networking domain.

### BACKGROUND OF THE INVENTION

Digital television (DTV) is implemented upon a set of standards that provide for the distribution of audio, video and data. As of this writing the MPEG standards are currently employed. Currently, broadcasters utilize the MPEG-2 transport stream formatting to deliver motion pictures, audio and digital data, including executable application data, to subscribers' equipment and/or applications. In this regard, although the MPEG-2 standard is in current use, the inventions discussed herein are not intended to be limited to such standard. Indeed, the inventions are adapted to evolve with evolving standards, allowing the inventions to be exploited both today and in the future.

Television viewers are, of course, aware that digital television will allow audio and video content to be delivered for enjoyment in the home. What many may not realize, however, is that the DTV standards also define data storage, retrieval and broadcasting services whereby digital information other than the audio and video content may be delivered to the home. By way of example, when it is necessary to upgrade the software in the home user's DTV receiver or set-top box, one or more files containing the digital information needed to perform the upgrade may be transmitted as part of the MPEG transport stream (according to the DTV standards mentioned above) to the receiver or set-top box. In some instances, this digital data may represent an executable program that is then launched and run on the local receiver or set-top box to affect the software upgrade.

The MPEG-2 standard, for example, provides a full set of protocols known as the digital storage medium command and control (DSM-CC) protocols that may be used to control the flow of this digital information between the video source and the receiving equipment. According to the roadmap outlined by the DSM-CC standards, after an initial link has been set up between two entities in a video delivery network (such as between the broadcast source and the user's receiver or set-top box) DSM-CC provides the functionality to continue the setup of an application session. Because this session setup happens at the interface between the network and the user equipment, DSM-CC defines a user-to-network protocol. Once the application session has been set up, further logical links are established between the video server and the receiver or set-top box. One logical link might be used for user data (like MPEG-2 coded video) and another logical link might be used to control what is happening on the user data link. This latter link is sometimes called the control link.

The actual protocol to be used on this control link is not specified by DSM-CC. However, DSM-CC defines a set of services (such as services to manipulate a video stream) in the server. These services can be used by the client on the receiver or set-top box. Because these services are primarily relevant between two user entities (such as the server and the client), the DSM-CC standard refers to them as the DSM-CC user-to-user interface (U-U interface). Thus the DSM-CC standards envision two fundamentally different interfaces, a user-network interface and a user-user interface. The user-network interface is used primarily for session setup and teardown and for managing the resources needed for the session. The user-user interface provides more application layer-oriented functions. For example, the user-user interface is used for application download communications and client-server communications.

Under the DSM-CC protocol, the user-user interface enables application download operations, which are primarily used for loading executable code from the server to a client. In a service on demand scenario, for example, a navigator application software program might be downloaded immediately after the session between the server and the client is set up. For such relatively straightforward download communication, the DSM-CC defines a simple message-based protocol, which implements a basic data flow-control mechanism.

There are, however, some applications where the simple data flow-control mechanism may not be sufficient. The DSM-CC thus provides for the use of a broadcasting approach to downloading digital data such as executable code from the server to a plurality of end users. To support broadcast download, the DSM-CC employs a data carousel which mediates the downloading of data. The data carousel supplies data continuously on a well defined download channel. Clients can tune to this channel, identify the data that is provided for download by analyzing periodically transmitted download control messages, and finally capturing the data the clients are interested in. A unified API is typically presented to applications and users to access data carousel directories, files and streams.

While the DTV standards, such as the DSM-CC standards, provide for basic object carousel access, there is presently not architecture for interfacing this functionality with the home networking domain with the goal of archiving DTV-centric broadcast-enabled home networking experience. Specifically, there is lacking a proxying mechanism that is capable of translating object carousel data into control and event messages intended for transmission into a home networking domain. Additionally, such architecture would also utilize gateway resources to provide to return channel functionality that would be required for functional home networking applications and services.

### SUMMARY OF THE INVENTION

An interactive television framework is provided for interfacing with a home networking domain. The interactive television framework includes: a carousel access mechanism that is operable to access object carousel data from a remotely located data carousel; and a carousel proxying agent in data communication with the carousel access mechanism. The carousel proxying agent actively translates object carousel data into home device control messages which are defined according to a plug-and-play protocol for transmission to the home networking domain.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

FIG. 1 illustrates an exemplary operational environment for an interactive television architecture;

FIG. 2 is a diagram depicting an exemplary embodiment of an interactive television framework for interfacing with a home networking domain according to the principles of the present invention;

FIG. 3 is a diagram illustrating a carousel proxying agent in accordance with the present invention; and

FIG. 4 is a diagram depicting an exemplary embodiment of an interactive television framework for interfacing with a home networking domain according to the principles of the present invention.

### DETAILED DESCRIPTION OF THE PREFERRED EMBODIMENTS

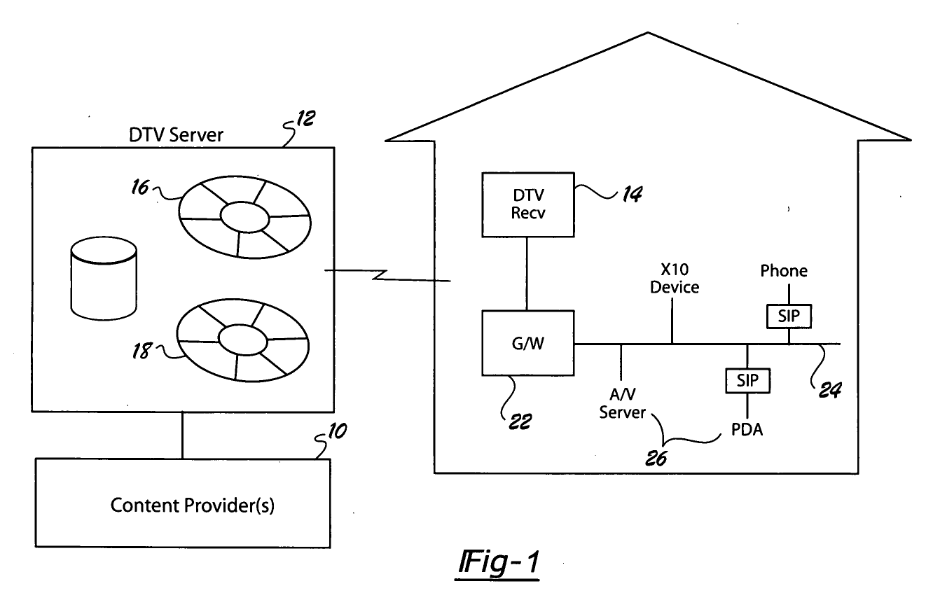

FIG. 1 illustrates an operational environment for an interactive television architecture in accordance with the present invention. The operational environment is generally comprised of a digital TV server 12 interconnected via a DTV receiver 14 (e.g., a set-top box) to a home networking domain 20. In an exemplary environment, the home networking domain 20 is comprised of a home gateway 22 interconnect by home network 24 to a plurality of home devices 26. It is readily understood that similar configurations are also within the scope of the present invention.

Digital data received from one or more content providers 10 is formulated by the digital TV server 12. In an exemplary embodiment, the DTV server 12 adheres to the DSM-CC protocol, such that digital data is configured on one or more data carousels. A broadcast content carousel 16 and an object carousel 18 have been illustrated in FIG. 1. These carousels operate to deliver the digital data over a suitable communication link to client devices as is well known in the art.

On the client side, a set-top box or other type of DTV receiver 14 is configured to access the digital data residing on the data carousels. A home gateway 22 then interfaces the DTV receiver 14 with the home networking domain 20. The home gateway 22 preferably functions in accordance with a gateway specification, such as Open Services Gateway Initiative (OSGi). However, it is readily understood that the broader aspects of the present invention encompass other gateway specifications as well as an absence of a gateway specification.

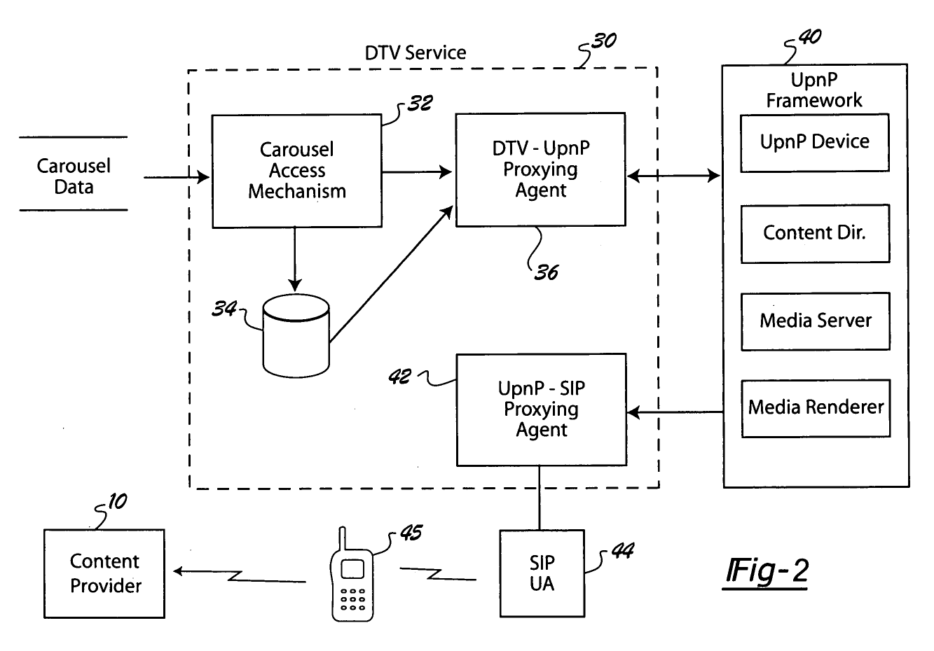

Referring to FIG. 2, a DTV service 30 is embedded into the DTV receiver. The DTV service 30 is generally comprised of a carousel access mechanism 32, an intermediate data store 34 and a carousel proxying agent 36 according to the principles of the present invention. In a conventional manner, the carousel access mechanism 32 retrieves broadcast content data from the broadcast content carousel 16 and outputs it to a television or some other type of A/V device. The carousel access mechanism 32 also retrieves object data from the object carousel 18. Select object data is then passed directly to the carousel proxying agent 36 or stored in the intermediate data store 34 for subsequent processing. Although preferably embedded in the DTV receiver 14, it is envisioned that the DTV service may be alternatively incorporated into the home gateway 22.

In operation, the carousel proxying agent 36 actively translates carousel object data into content which is compatible with the home networking domain. In an exemplary embodiment, the home networking domain is defined in accordance with a plug-and-play device framework 40, such as UPnP. A basic understanding of the UPnP protocol as provided below will be helpful to better understanding this aspect of the present invention. While UPnP has currently gained industry-wide favor, it is readily understood that other similar protocols fall within the scope of the present invention.

Briefly, the UPnP protocol defines three basic abstractions: devices, services, and control points. An UPnP device can be any entity on a network that implements the protocols required by the UPnP architecture. UPnP standardizes the protocols through which a device communicates, rather than the application programming interfaces that are used to connect to the device. Thus a device that speaks the required protocols is an UPnP device.

An UPnP service is a unit of functionality implemented by a device. Each service is typically defined as a set of methods or actions, each with a set of optional input and output parameters and an optional return value. In general, a given device type will have a set of required services that the device must implement. For example, a CD player would have a service that provides the ability to play, pause and stop the audio content.

An UPnP control point is an entity on the network that invokes the functionality provided by a device. One can think of the control point as a client and the device as the server. The control point invokes an action, by sending a properly configured communication to a device thereby invoking one or more of the device's services. The device may then provide a return value to the control point. In general, any entity that invokes the services of an UPnP device is a control point. This allows UPnP devices to also function as control points, whereby one device can invoke the services or monitor state changes in another device. It is upon this basic communication scheme that a home networking domain may be built.

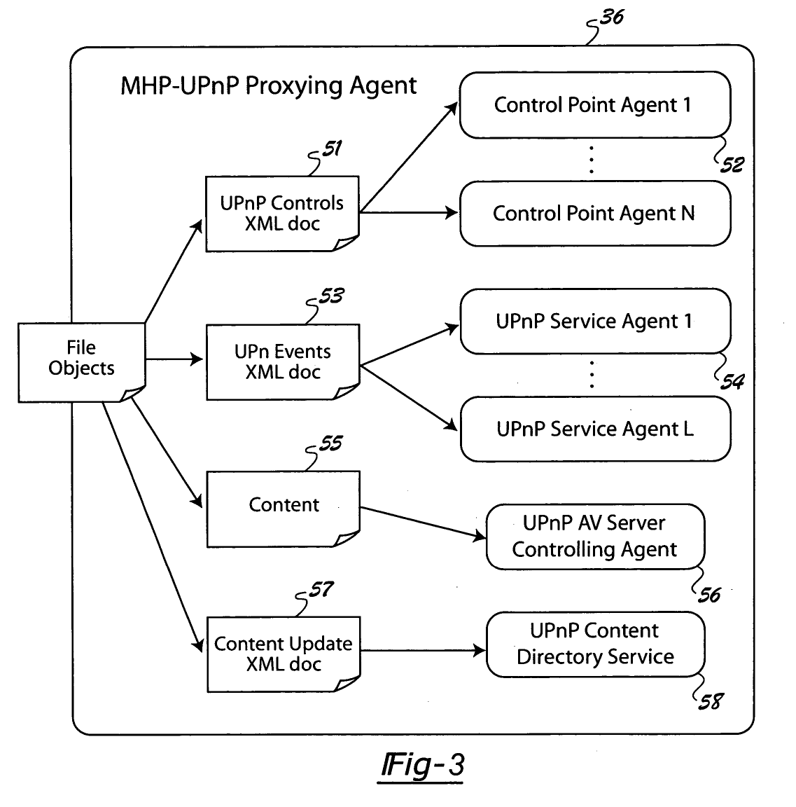

Depending upon the type of object data, the carousel proxying agent 36 performs different proxy functions as shown in FIG. 3. For example, the object data may specify an UPnP control message intended for a home networked device. In an exemplary embodiment, the object data is in the form of an XML controls document 51 whose contents may include a network device identifier, a service identifier and other control parameters needed to specify an UPnP control message. In this case, the carousel proxying agent 36 provides a control point agent 52 which serves as a control point in the context of UPnP. The control point agent 52 translates the XML document content into one or more UPnP control messages and then sends the message(s) to designated devices within the home networking domain. Such control messages may be sent by the control point agent 52 in accordance with the Simple Object Access Protocol (SOAP). It is understood that home device control messages may be sent in accordance with other protocols which are compatible within the home networking domain.

In one aspect of the present invention, functionality invoked within the home networking domain may be synchronized with broadcast content being viewed. For example, when the wheel is spun during the WHEEL OF FORTUNE game show, the lights in the viewer's room may be flickered. In this example, the control message is a command to one or more lighting devices within the viewing room.

To realize synchronization, the carousel proxying agent may be further configured to monitor broadcast content data from the carousel access mechanism. In addition, the object data further includes at least one condition for initiating the control message. For instance, the object data may include a MPEG stream identifier and a frame number indicating the timing at which the control message should be sent or executed by the home device. Presumably, the object data for flickering the lights precedes the corresponding broadcast data for the WHEEL OF FORTUNE game show. The carousel proxying agent formulates the control message(s) for the lighting devices upon receipt of the object data and then monitors the arrival of the broadcast data. When the appropriate broadcast data is received, the carousel proxying agent then transmits the control message(s) to the lighting devices. In this way, functionality invoked within the home networking domain may be synchronized with broadcast content being viewed.

In an alternative approach, XML control documents may be stored by the carousel access mechanism 32 in the intermediate data store 34. The carousel proxying agent 36 monitors the broadcast content data for time synchronization markers embedded therein. Upon receipt of a time synchronization marker, the carousel proxying agent 36 searches the intermediate data store for matching UPnP control messages. When a match is found, the carousel proxying agent 36 formulates and transmits the UPnP control messages to the designated home device in the manner described above. It should be appreciated that other techniques for synchronizing the control messages with the broadcast content are also within the scope of the present invention.

In another example, the object data may be UPnP eventing messages which are encapsulated in an XML document 53. In this case, the carousel proxying agent 36 provides an UPnP service agent 54 which provides the communication link between a service and subscribed control points. The UPnP service agent 54 translates the document content into one or more event messages and then sends the event messages to subscribing control points. Event messages may be sent using GENA or other eventing protocols.

In yet another example, the object data may be content which is sent by a server controlling agent 56 to an UPnP AV Server. Similarly, the object data may be content updates 57 which are sent by a directory service agent 58 to an UPnP Content Directory Service. For example, a song delivered over the object carousel is stored in the UPnP AV Server with a corresponding update of the UPnP Content Directory. It is readily understood that the carousel proxying agent 36 may include other types of executable agents for translating object data into UPnP compatible data formats. In addition, the carousel proxying agent 36 may be used to deliver other types of information, including but not limited to device drivers for home networking devices or data payloads (state variables, etc.) for device drivers.

Returning to FIG. 2, the proposed interactive television architecture can also provide a more robust interactive viewing experience through the use of an on-demand return channel. Perhaps a game show being viewed offers the viewers an opportunity to participate from home. For instance, a viewer who correctly answers a question may be eligible to win a prize. In this instance, the viewer's answer input may be captured by an application residing on one of the home devices (e.g., a PDA or a personal computer) connected to the home network. It is envisioned that the application has been downloaded via the broadcast channel or some other communication link (e.g., Internet) from a content provider.

Captured user input is sent to the content provider via an on-demand return channel made available through the home networking domain. IN one example, the application may interact with a modem to establish a communication link to an Internet provider. The application may then send an email message encapsulating the user input to the content provider.

In another example, the application may interact with or reside on a mobile communication device, such as a cellular phone, where the mobile device is interconnected to the home networking domain through the use of the Session Initiation Protocol (SIP). To do so, an UPnP-SIP proxying agent 42 is incorporated into the interactive television architecture. The UPnP-SIP proxying agent 42 operates to translate UPnP messages into SIP requests and transmit SIP requests to a SIP User Agent 44 residing on a mobile SIP device 45. The mobile SIP device is further configured to establish a communication link with the content provider. In this way, a viewer's input may be captured at a home networking device which is interconnected to a mobile SIP device that provides the return channel to the content provider. It is readily understood that other suitable message protocols and other types of return channels are also within the scope of the present invention.

The content provider may in turn respond to input from the broadcast viewer's. In the case of the game show, one or more prize winners may be selected from viewers whom correctly answered the question. The content provider may then modify carousel data so that the names of selected viewers are displayed to the viewing audience. In addition, the content provider may further modify the carousel data to invoke additional functionality supported by the home networking domain. For instance, a triumphant audio clip may be downloaded to the viewer's home network and played simultaneously with the display of the winning viewers.

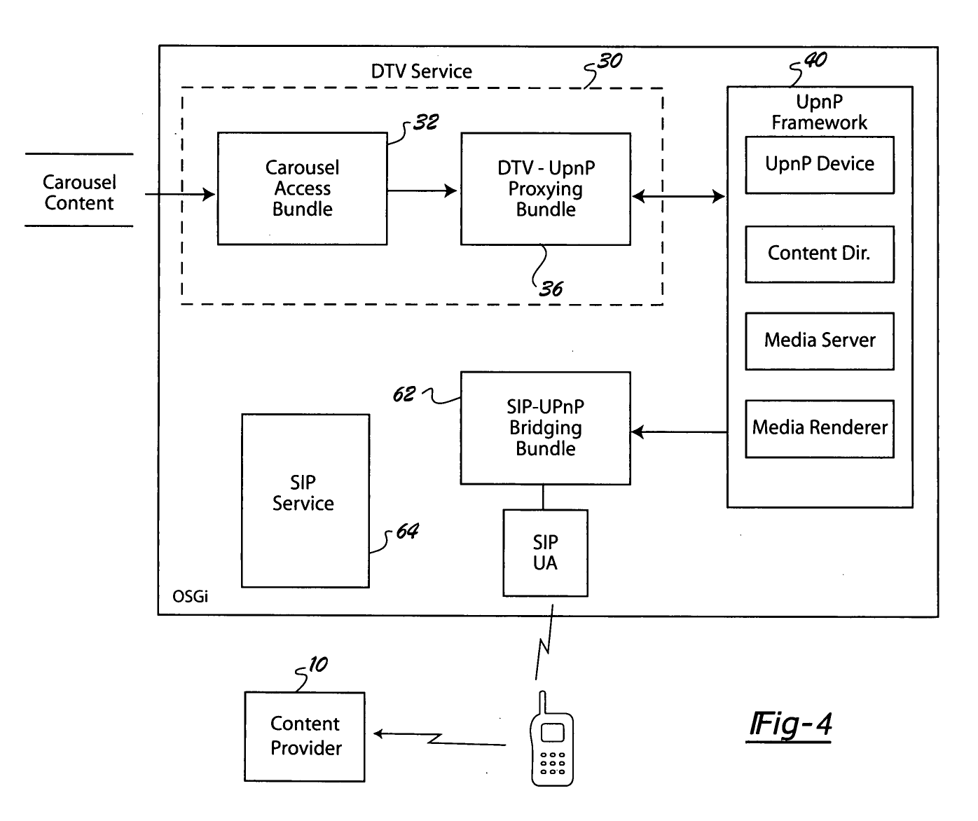

In an alternative embodiment, the DTV service 30 may be integrated with a home gateway as shown in FIG. 4. For illustration purposes, the home gateway functions in accordance with OSGi. The carousel access mechanism 32 and/or the carousel proxying agent 36 are implemented as OSGi bundles, but otherwise function in a similar manner as described above. However, it is readily understood that other gateway specifications are also within the scope of the present invention.

To interface with mobile devices, the home gateway may further include an UPnP bridging bundle 62 and a SIP Service 64. SIP Service 64 is also an OSGi bundle which enables SIP entities to register with itself and translates such registrations into gateway aware registrations. The UPnP bridging bundle 62 translates UPnP messages into SIP requests which are passed on to a SIP registered entity for further processing. In this way, the home gateway provides an interface between UPnP devices and mobile SIP devices. Further information regarding an exemplary SIP Service may be found in U.S. patent application Ser. No. 10/894,469 entitled “SIP Service for Home Network Device and Service Mobility” and filed on Jul. 19, 2004 which is incorporated by reference herein.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. An interactive television framework for interfacing with a home networking domain having a plurality of home devices defined in accordance with a plug-and-play protocol, comprising:
a carousel access mechanism operable to access broadcast content data and object carousel data from a data carousel; and
a carousel proxying agent in data communication with the carousel access mechanism and actively translates the object carousel data into a home device message, where the home device message is defined according to a plug-and-play protocol for transmission in the home networking domain.

2. The interactive television framework of claim 1 wherein the object carousel data specifies an identifier for a designated home device or service, a command for the designated home device or service, and at least one condition for initiating the command.

3. The interactive television framework of claim 1 wherein the plug-and-play protocol is further defined as UPnP.

4. The interactive television framework of claim 1 wherein the object carousel data describes control message content in accordance with UPnP.

5. The interactive television framework of claim 1 wherein the object carousel data describes event message content in accordance with UPnP.

6. The interactive television framework of claim 1 wherein the object carousel data describes at least one of content for UPnP AV Server or content updates for UPnP Content Directory.

7. The interactive television framework of claim 1 wherein the object carousel data includes scheduling information for the home device messages.

8. The interactive television framework of claim 1 wherein the object carousel data is further defined as an XML document.

9. The interactive television framework of claim 1 wherein the carousel proxying agent is further operable to transmit the home device message a designated home device, such that the designated home device performs a device operation in accordance with the control message.

10. The interactive television framework of claim 1 further comprises a return data channel interconnecting an application associated with the home networking domain to a content provider of the broadcast content data.

11. The interactive television framework of claim 10 wherein the application is configured to capture input from a viewer of the broadcast content data and operable to transmit the input via the return data channel to the content provider.

12. The interactive television framework of claim 11 wherein the content provider alters carousel data based on the input received from the viewer.

13. The interactive television framework of claim 10 wherein the return data channel is provided by one of the home devices connected to the home network.

14. The interactive television framework of claim 10 wherein the return data channel is provided by a mobile communication device connected via a session initiation protocol (SIP) to the home network.

15. The interactive television framework of claim 14 further comprises a UPnP-SIP proxying agent adapted to receive UPnP messages from the home devices and operable to translate the UPnP messages into SIP requests for use by SIP entities.

16. An interactive television framework for interfacing with a home networking domain having a gateway defined in accordance with a gateway specification and a plurality of home devices interconnected to the gateway, comprising:
a carousel access mechanism implemented as a software bundle registered with the gateway and operable to access broadcast content data and object carousel data from a data carousel; and
a carousel proxying agent registered with the gateway and operable to actively translate the object carousel data into a home device message, where the home device message is defined according to a plug-and-play protocol for transmission in the home networking domain.

17. The interactive television framework of claim 16 wherein the gateway specification is further defined as an Open Services Gateway Initiative (OSGi) specification, such that the carousel access mechanism is implemented as an OSGi bundle within the gateway of the home networking domain.

18. The interactive television framework of claim 16 wherein the plug-and-play protocol is further defined as UPnP.

19. The interactive television framework of claim 16 wherein the object carousel data describes at least one of control message content in accordance with UPnP, event message content in accordance with UPnP, content for UPnP AV Server or content updates for UPnP Content Directory.

20. The interactive television framework of claim 16 wherein the object carousel data includes scheduling information for the home device messages and the carousel proxying agent transmits the home device message to a designated home device based on the scheduling information.

21. The interactive television framework of claim 20 wherein the scheduling information is further defined as an MPEG stream identifier and a frame identifier for the broadcast content data which is to be synchronized with the home device message.

22. The interactive television framework of claim 15 further comprises a return data channel interconnecting an application associated with the home networking domain to a content provider of the broadcast content data.

23. The interactive television framework of claim 22 wherein the application is configured to capture input from a viewer of the broadcast content data and operable to transmit the input via the return data channel to the content provider.

24. The interactive television framework of claim 23 wherein the content provider alters carousel data based on the input received from the viewer.

25. The interactive television framework of claim 22 wherein the return data channel is provided by one of the home devices connected to the home network.

26. The interactive television framework of claim 22 further includes a SIP Service that enables SIP entities to register with itself and translates such registration into gateway aware registrations, such that the return data channel is provided by a mobile communication device in data communication with a SIP entity residing in the home networking domain.

27. An interactive television framework for interfacing with a home networking domain having a gateway defined in accordance with a gateway specification and a plurality of home devices interconnected via a home network to the gateway, comprising:
a carousel access mechanism operable to access broadcast content data and object carousel data from a remotely located data carousel; and
an carousel proxying agent in data communication with the carousel access mechanism, the carousel proxying agent operable to monitor the broadcast content data and translate object carousel data into a home device control message based in part on the broadcast content data, where the control message is defined according to a plug-and-play protocol for transmission to the home networking domain.

28. The interactive television framework of claim 27 wherein the object carousel data specifies an identifier for a designated home device or service, a command for the designated home device or service, and at least one condition for initiating the command.

29. The interactive television framework of claim 27 wherein the plug-and-play protocol is further defined as UPnP.

30. The interactive television framework of claim 27 wherein the gateway specification is further defined as an Open Services Gateway Initiative (OSGi) specification, such that the carousel access mechanism is implemented as an OSGi bundle within the gateway of the home networking domain.

31. The interactive television framework of claim 27 wherein the carousel proxying agent is further operable to transmit the home device message a designated home device, such that the designated home device performs a device operation in accordance with the control message.

32. The interactive television framework of claim 27 further comprises a return data channel interconnecting an application associated with the home networking domain to a content provider of the broadcast content data.

33. The interactive television framework of claim 32 wherein the application is configured to capture input from a viewer of the broadcast content data and operable to transmit the input via the return data channel to the content provider.

34. The interactive television framework of claim 33 wherein the content provider alters carousel data based on the input received from the viewer.
